(19) United States
(12) Patent Application Publication
(10) Pub. No.: US 2017/0080485 A1
(43) Pub. Date: Mar. 23, 2017

(54) Non-Magnetic Steel Structure For A Steel Or Aluminium Making Process

(71) Applicant: ABB Schweiz AG, Baden (CH)

(72) Inventors: Conny Svahn, Västerås (SE); Jan-Erik Eriksson, Västerås (SE); Lidong Teng, Västerås (SE)

(21) Appl. No.: 15/308,042

(22) PCT Filed: Jun. 16, 2014
(86) PCT No.: PCT/EP2014/062511

§ 371 Date: Oct. 31, 2016

(51) Int. Cl. B22D 11/12; C22C 38/04; C22C 38/02; B22D 41/08; F27D 27/00; B22D 11/115; B22D 11/128; B22D 27/02; C22C 38/06; F27D 11/08

(52) U.S. Cl. CPC B22D 11/122; C22C 38/06; C22C 38/04; C22C 38/02; F27D 11/08; F27D 27/00; B22D 11/115; B22D 11/128; B22D 27/02; B22D 41/08

(57) ABSTRACT

A non-magnetic steel structure for a steel or aluminium making process, which non-magnetic steel structure is arranged to enable penetration of a magnetic field from an electromagnetic stirrer or electromagnetic brake into a melt in a vessel for molten metal, wherein the non-magnetic steel structure includes manganese in the range 12-40 mass %.

### TECHNICAL FIELD

The present disclosure generally relates to production of metal such as steel or aluminium. In particular, it relates to a non-magnetic steel structure, which enables the transmission of a magnetic field from an electromagnetic stirrer or brake to the melt.

### BACKGROUND

In production of metal, solid metal material such as scrap is arranged in an electric arc furnace in which the solid metal material is smelted and a melt is formed. In this process, an electromagnetic stirrer may be utilised for stirring the mix of still solid metal material and the melt to even the temperature in the electric arc furnace. The melt is then tapped from the electric arc furnace to a ladle, where the melt may be further treated. Also in this step an electromagnetic stirrer may be arranged to stir the melt in the ladle. In a further step, the melt is tapped into the caster, i.e. the casting mould, for example via a tundish. The casting mould may also be provided with an electromagnetic stirrer for controlling the flow of the melt as it turns into a semi-solidified strand. The semi-solidified strand exits the casting mould and travels along a path of support rolls. Also in this latter part of the casting process when the strand travels along the path of support rolls, an electromagnetic stirrer may be arranged to provide stirring of the non-solid interior of the semi-solidified strand.

An electric arc furnace, an aluminium furnace, a ladle and a casting mould may with a common term be referred to as vessels for molten metal. In all of the above steps the housing of the electromagnetic stirrer, as well as the non-magnetic window of the vessels for molten metal, i.e. the wall or floor which is arranged to permit penetration of the magnetic field from the electromagnetic circuit of the electromagnetic stirrer or brake into the melt contained in the vessel for molten metal, preferably comprises a non-magnetic material for reducing losses due to eddy currents which would otherwise be induced into these structures. The efficiency of the stirring may thus be increased. Today, austenitic stainless steel is typically used as material for the electromagnetic stirrer housing, as well as for the non-magnetic window. Examples of austenitic stainless steel used today are AISI 304, 309 and 316. The particular type of austenitic stainless steel utilised depends on the mechanical property requirements. Austenitic stainless steel is non-magnetic, and has well-documented durability in the harsh environments present in continuous casting. The austenitic stainless steel windows of vessels for metal making and the housing of electromagnetic stirrers and electromagnetic brakes however do generate magnetic losses, and are furthermore relatively expensive, normally two to five times higher than carbon steel which used in structures where electromagnetic stirring is not applied.

### SUMMARY

In view of the above, an object of the present disclosure is to provide a non-magnetic steel structure for a steel or aluminium making process, which solves or at least mitigates existing problems.

Hence, according to a first aspect of the present disclosure there is provided a non-magnetic steel structure for a steel or aluminium making process, which non-magnetic steel structure is arranged to enable penetration of a magnetic field from an electromagnetic stirrer or electromagnetic brake into a melt in a vessel for molten metal, wherein the non-magnetic steel structure comprises manganese in the range 12-40 mass %.

To be able to use steel comprising manganese in the range provided above, also referred to as high manganese steel (HMS), in electromagnetic devices and in material which needs to be penetrable to magnetic fields, the physical properties of HMS have been studied carefully, and the inventors have found that HMS fulfils the requirements as non-magnetic steel in these applications.

By means of the non-magnetic steel structure the chromium and nickel composition of austenitic stainless steel may be replaced with 12-40 mass % manganese. The mass percentage is the amount of manganese of the total mass of the non-magnetic steel structure. A mass percentage of manganese within this range renders the non-magnetic steel structure fully austenitic and thus non-magnetic. Manganese is substantially less expensive than the chromium and nickel composition used in austenitic stainless steel structures for continuous casting. Furthermore, the relative permeability of the non-magnetic steel structure is lower than for austenitic stainless steel structures. In particular, tests have shown that the relative permeability may be as low as 1.003, which is lower than the relative permeability of austenitic stainless steel. Magnetic losses may thus be reduced compared to stainless steel structures.

According to one embodiment the manganese is in the range 12-30 mass %.

According to one embodiment the manganese is in the range 16-30 mass %. It is generally desirable to include as high mass percentage of manganese as possible; a higher manganese mass % may facilitate the workability of the material when manufacturing the non-magnetic steel structure for example, which may result in lower production costs.

According to one embodiment the manganese is in the range 18-30 mass %.

According to one embodiment the manganese is in the range 20-30 mass %.

According to one embodiment the manganese is in the range 20-25 mass %.

One embodiment comprises carbon in the range 0.5-1.0 mass %. By including carbon in this range in the non-magnetic steel structure, the durability or mechanical strength of the non-magnetic steel structure may be increased. In particular, the combination of manganese in the above-provided range with carbon in the range 0.5-1.0 mass % results in that the yield strength of the non-magnetic steel structure may essentially be doubled from 215 MPa for austenitic stainless steel used in steel or aluminium making applications to about 400 MPa. The non-magnetic steel structure may therefore be dimensioned to be thinner, i.e. to have a thinner wall thickness, than corresponding stainless steel structures. Losses are proportional to the thickness of the material, and thinner walls thus provide lower losses. Furthermore, by means of thinner walls less material is necessary for producing the non-magnetic steel structure, resulting in a smaller environmental footprint, and costs may be kept lower.

One embodiment comprises aluminium in the range 0.1-1.5 mass %.

One embodiment comprises silicon in the range 0.05-1.5 mass %.

By means of the aluminium and silicon in the above-defined ranges production of the non-magnetic steel structure may be facilitated.

According to one embodiment the non-magnetic steel structure is one of a housing of an electromagnetic stirrer or electromagnetic brake, a window of a ladle, a window of an electromagnetic arc furnace or an aluminium furnace, a window of a casting mould, and a strand support roller for supporting semi-solidified strands. The non-magnetic steel structure may thus beneficially be a structure which either is the housing of an electromagnetic stirrer or brake for a continuous casting process, or the non-magnetic window of a vessel for molten metal. The non-magnetic steel structure is essentially transparent for magnetic fields generated by the electromagnetic circuit of an electromagnetic stirrer, thus providing low-loss magnetic field transmission to the melt while maintaining the high mechanical strength required in a steel or aluminium making process.

The non-magnetic steel structure may thus beneficially be utilised in a vessel for molten metal for a steel or aluminium making process. Such a vessel for molten metal may hence comprise refractory material forming an internal lining of the vessel for molten metal, and the non-magnetic steel structure forms part of an external shell of the refractory material, and forming a non-magnetic window of the vessel for molten metal.

The non-magnetic steel structure may furthermore also be utilised in an electromagnetic stirrer or brake for a steel or aluminium making process. Such an electromagnetic stirrer for a continuous casting process may thus comprise an electromagnetic circuit arranged to generate a magnetic field, and a non-magnetic steel structure forming a non-magnetic housing of the electromagnetic circuit.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIGS. 1A-B are schematic perspective views of examples of vessels for molten metal comprising non-magnetic steel structures; and

FIG. 2 schematically shows a perspective view of a steel or aluminium making process.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

A non-magnetic steel structure and examples thereof will be described herein. The non-magnetic steel structure is adapted to be used in a steel or aluminium making process. This can be obtained by proper dimensioning of the non-magnetic steel structure, for example by adapting the thickness of the non-magnetic steel structure to be able to withstand the mechanical requirements in a steel or aluminium making environment, and by means of the chemical composition of the non-magnetic steel structure, which will be elaborated upon in the following.

The non-magnetic steel structure enables a magnetic field to penetrate through it. This is achieved by including manganese in the non-magnetic steel structure. By means of the manganese, the non-magnetic steel structure may obtain a fully austenitic steel structure. The non-magnetic property of the non-magnetic steel structure is thus obtained.

Preferably, the manganese is in the range 12-40 mass %, although a higher mass percentage manganese is also envisaged. The manganese replaces the chromium and nickel composition of austenitic stainless steel normally used in continuous casting for the non-magnetic window of vessels for metal making and for the housing of electromagnetic stirrers and electromagnetic brakes.

According to one variation, the non-magnetic steel structure comprises manganese in the range 12-30 mass %.

According to one variation, the non-magnetic steel structure comprises manganese in the range 16-30 mass %.

According to one variation, the non-magnetic steel structure comprises manganese in the range 18-30 mass %.

According to one variation, the non-magnetic steel structure comprises manganese in the range 20-30 mass %.

According to one variation, the non-magnetic steel structure comprises manganese in the range 12-25 mass %, for example 16-25 mass %, or 18-25 mass %, or 20-25 mass %.

The non-magnetic steel structure may further comprise carbon, aluminium and silicon. In general, the non-magnetic steel structure comprises substantially less carbon, aluminium and silicon, in mass %, compared to the manganese content.

According to one variation the non-magnetic steel structure comprises carbon in the range 0.5-1.0 mass %.

According to one variation the non-magnetic steel structure comprises aluminium in the range 0.1-1.5 mass %.

According to one example the non-magnetic steel structure comprises silicon in the range 0.05-1.5 mass %.

In addition to the above-mentioned chemical elements, the non-magnetic steel structure may comprise iron. According to one variation, the remaining content of the non-magnetic steel structure is composed of iron.

Table 1 below illustrates the required properties of non-magnetic steel material for electromagnetic applications (EM) in a steel or aluminium making environment. It furthermore provides the corresponding properties for high manganese steel as proposed in this disclosure and for austenitic stainless steel currently used in electromagnetic applications.

TABLE 1

| | General | | |
|---|---|---|---|
| | requirements of | | |
| | non-magnetic | | Properties of austenitic |
| | steel for EM | | stainless steel used in |
| Properties | applications | Properties of HMS | EM applications |
| Magnetic | Non-magnetic | Fully non- | Non-magnetic |
| | | magnetic | |
| Magnetic stability | Slightly unstable | Stable | Slightly unstable |
| | is okay | | |
| Relative permeability | Maximum 1.5 | 1.003 | 1.008 (AISI 304, 316) |
| Resistivity μΩm at 20° C. | 0.6 | 0.62 | 0.72 (AISI 304), |
| | | | 0.74 (AISI 316) |
| Yield strength (MPa), | Min 215 | 400 | 215 (AISI 304), |
| annealed | | | 290 (AISI 316) |
| Yield strength at 700° F. | Min 130 | Currently not | 134 (AISI 304), |
| | | known | 159 (AISI 316) |
| Elongation at | 50% | Uniform | 70% (AISI 304), |
| break in 50 mm | | elongation more | 50% (AISI 316) |
| | | than 50% | |
| Machining | Good | Special tools | Good |
| | | needed | |
| Cutting | Gas cutting | Plasma cutting | Gas cutting |
| Welding non-magnetic | Acceptable | Good | Acceptable |
| steel to each other | | | |
| Welding non-magnetic | Difficult | Good | Difficult |
| steel to carbon steel | | | |
| Hardness | As austenitic | Core 220 HB, skin | 123 HB (AISI 304), |
| | stainless steel | 550 HB after | 149 HB (AISI 316), |
| | | impact | annealed |
| Wear resistance | Not required | Extremely good | Not required |
| Materials cost | As low as possible | Less than half of | — |
| | | stainless steel | |

The non-magnetic steel structure may for example be the housing of an electromagnetic stirrer such as a ladle stirrer or ladle furnace stirrer, an aluminium furnace stirrer, a strand stirrer, a final strand stirrer, a mould stirrer, an electromagnetic arc furnace stirrer, or an electromagnetic brake e.g. for a caster or mould. In these cases, the non-magnetic steel structure hence forms part of an electromagnetic stirrer or electromagnetic brake. Alternatively, the non-magnetic steel structure could define a non-magnetic window of a vessel for molten metal. In this case the non-magnetic steel structure, i.e. non-magnetic window, is adapted to be inserted into for example a ladle, an electric arc furnace, or a casting mould. Alternatively, the non-magnetic steel structure could form part of a non-magnetic strand support roller arranged to support strands exiting the casting mould. In the latter two cases, i.e. when the non-magnetic steel structure defines a non-magnetic window or a strand support roller, the non-magnetic steel structure enables the penetration of a magnetic field from electromagnetic stirrers.

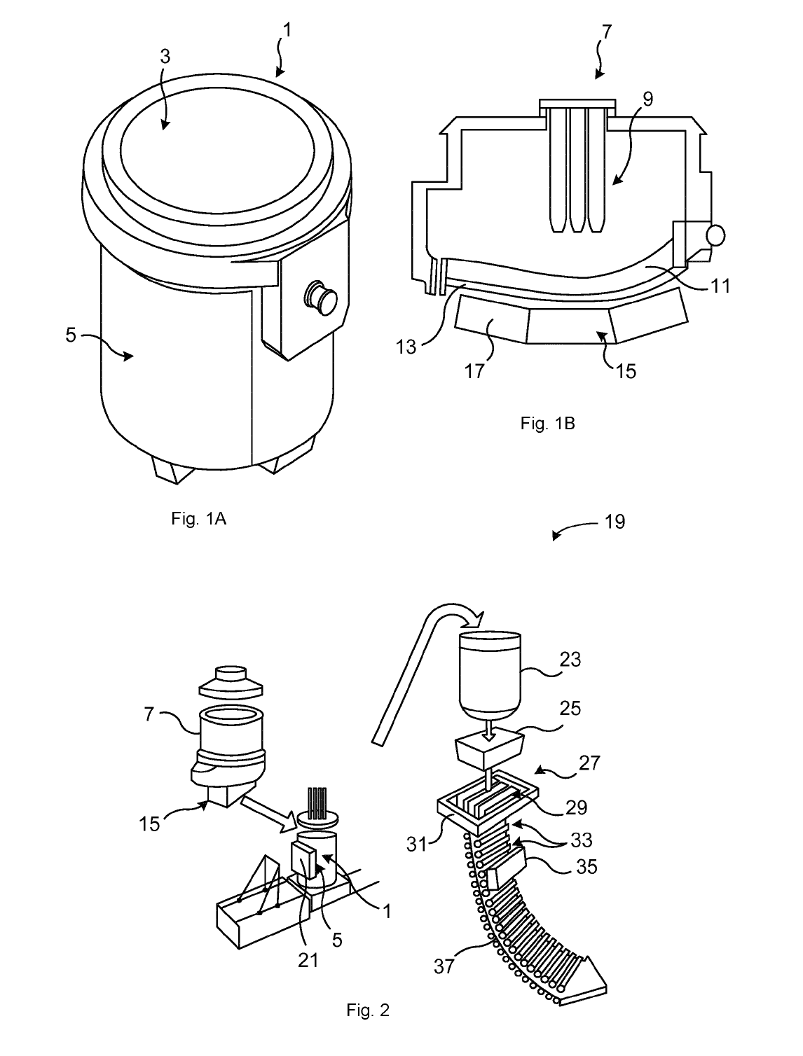

In the following, examples of the non-magnetic structures described above, and examples of specific applications thereof will be provided with reference to FIGS. 1-2. FIGS. 1a and 1b show examples of vessels for molten metal which comprise a non-magnetic steel structure according to any variation described herein.

FIG. 1a depicts an example of a ladle 1 for a steel or aluminium making process. The ladle 1, which may be a treatment ladle and/or a ladle furnace and/or a transport ladle, forms a vessel into which melt may be tapped for example from an electric arc furnace. The ladle 1 comprises a refractory material 3 which forms an inner lining and defines the inner walls of the ladle 1. The ladle 1 further comprises a non-magnetic window 5, in the form of the non-magnetic steel structure. The non-magnetic steel structure hence forms an external wall of the ladle 1. In particular, the non-magnetic steel structure, i.e. the non-magnetic window 5, defines a wall which enables penetration of a magnetic field applied to the non-magnetic steel structure by means of an electromagnetic stirrer, not shown in FIG. 1a.

Typically, about one third of a ladle wall, facing the electromagnetic stirrer, may be made of non-magnetic material. To illustrate the economic benefits with the non-magnetic steel structure, a 130 tonnes ladle has a non-magnetic window which may weigh about 2.5 tonnes. The price of the HMS described herein is about half of that of austenitic stainless steel, which according to current prices would provide a cost reduction of about 4500 USD per ladle. The typical number of ladles in one mill is about 12, wherein the total savings for one installation is about 54 000 USD. Additional economical savings as well as material savings may be obtained due to the possibility to design non-magnetic windows with thinner walls than in currently existing non-magnetic windows.

FIG. 1b depicts an example of an electric arc furnace 7 for a steel making process. The electric arc furnace 7 forms a vessel into which solid metal material may be loaded. The electric arc furnace has electrodes 9 arranged to heat the solid metal material and the melt obtained by smelting the solid metal material. The electric arc furnace 7 has a refractory material 11 which defines the inner surface and inner walls of the electric arc furnace 7. The exemplified electric arc furnace 7 further comprises the non-magnetic steel structure in the form of a non-magnetic window 13, which forms an external wall or bottom shell of the refractory material 11 that defines the bottom of the electric arc furnace 7. An electromagnetic stirrer 15 placed below the electric arc furnace 7, and adjacent to the non-magnetic window 13 may thereby provide a magnetic field which is able to penetrate the non-magnetic window 13 into the melt, not shown in FIG. 1b.

As an example, for a 100 tonnes electric arc furnace, the weight of the non-magnetic window may be about 7 tonnes which can provide an economical saving of about 12500 USD per electric arc furnace by replacing an austenitic stainless steel non-magnetic window with the non-magnetic steel structure, even if the wall thickness is the same. Additional economical and material savings may be made if the thickness of the non-magnetic wall is reduced, which is a possibility because the yield strength is almost twice the yield strength of AISI 304 and about 40% higher than the yield strength of AISI 316.

The electromagnetic stirrer 15 has a housing 17 which may be a non-magnetic steel structure as described herein. The electromagnetic stirrer 15 further comprises an electromagnetic circuit, arranged within the housing 17, arranged to generate a magnetic field. The non-magnetic steel structure, i.e. the housing 17, enables a magnetic field to penetrate the housing without the induction of eddy currents in the housing.

As previously noted, in general any electromagnetic stirrer or electromagnetic brake for a steel or aluminium making process, e.g. a ladle stirrer or ladle furnace stirrer, an aluminium furnace stirrer, a strand stirrer, a final strand stirrer, a mould stirrer or an electromagnetic arc furnace stirrer, may comprise a housing which is a non-magnetic steel structure as described herein.

FIG. 2 shows an example of the production flow in a metal making environment 19, e.g. a steel making environment, with the purpose to illustrate for example where in the steel or aluminium making process the non-magnetic steel structure according to any variation described herein may be utilised. The general production flow is shown by means of the arrows. In the example of FIG. 2, a plurality of vessels for molten metal are provided with a non-magnetic steel structure according to any variation described herein. Furthermore, a plurality of electromagnetic stirrers are shown having a housing in the form of the non-magnetic steel structure according to any variation described herein.

In FIG. 2 the metal making process begins in the electric arc furnace 7 in which the melt is stirred by means of the electromagnetic stirrer 15. The melt is tapped into the ladle 1, in the example in FIG. 2 exemplified by a ladle furnace/transport ladle. An electromagnetic stirrer 21 is arranged to provide a magnetic field, penetrating the non-magnetic window 5, i.e. a non-magnetic steel structure according to any variation described herein, to stir the melt. The melt is then tapped to another ladle 23, wherein the melt is further tapped into a tundish 25. From the tundish 25, the melt is tapped into a casting mould 27 which has walls 29 made of the non-magnetic steel structure according to any variation described herein. An electromagnetic stirrer 31 is provided around the casting mould 27, arranged to stir the melt tapped into the casting mould 27. A semi-solidified strand 37 exits the casting mould 27 and is supported by strand support rollers 33, which together with the casting mould 27 defines the caster, as the semi-solidified strand 37 moves by means of the motor-driven support rollers 33 through the caster. An electromagnetic stirrer 35 is arranged behind the strand support rollers 33 to stir the semi-solidified strand 37.

For both the electromagnetic stirrer or electromagnetic brake housing and vessel for molten metal, the entire housing and/or the entire outer walls of the vessel for molten metal could be a non-magnetic steel structure according to any variation described herein. Alternatively, only the portion of the housing and/or the vessel for molten metal which should be penetrable to a magnetic field may be a non-magnetic steel structure according to any variation described herein.

An example of a suitable HMS material is manufactured by the company POSCO, called High Mn TWIP. In general any HMS which has a chemical composition according to the examples described herein may be utilised.

The non-magnetic steel structures, and electromagnetic stirrers, brakes and vessels for molten metal comprising such a non-magnetic steel structure, may beneficially be utilised in metal making, for example in steel production or aluminium production.

The inventive concept has mainly been described above with reference to a few examples. However, as is readily appreciated by a person skilled in the art, other embodiments than the ones disclosed above are equally possible within the scope of the inventive concept, as defined by the appended claims.

1. A fully austenitic high manganese non-magnetic steel structure for a steel or aluminium making process, wherein the non-magnetic steel structure is one of a housing of an electromagnetic stirrer or electromagnetic brake, a window of a ladle, a window of an electromagnetic arc furnace or an aluminium furnace, a window of a casting mould, and a strand support roller for supporting semi-solidified strands, and wherein the non-magnetic steel structure consists of manganese in the range 12-40 mass %, carbon in the range 0.5-1.0 mass %, aluminium in the range 0.1-1.5 mass %, silicon in the range 0.05-1.5 mass %, the remaining content of the non-magnetic steel structure being composed of iron and impurities.

2. The non-magnetic steel structure as claimed in claim 1, wherein the manganese is in the range 12-30 mass %.

3. The non-magnetic steel structure as claimed in claim 1, wherein the manganese is in the range 16-30 mass %.

4. The non-magnetic steel structure as claimed in claim 1, wherein the manganese is in the range 18-30 mass %.

5. The non-magnetic steel structure as claimed in claim 1, wherein the manganese is in the range 20-30 mass %.

6. The non-magnetic steel structure as claimed in claim 1 wherein the manganese is in the range 20-25 mass %.

7. A vessel for molten metal for a continuous casting process, wherein the vessel for molten metal is one of an electric arc furnace and a ladle, which vessel comprises:
a refractory material forming an internal lining of the casting vessel, and
a non-magnetic steel structure wherein the non-magnetic steel structure is one of a housing of an electromagnetic stirrer or electromagnetic brake, a window of a ladle, a window of an electromagnetic arc furnace or an aluminium furnace, a window of a casting mould, and a strand support roller for supporting semi-solidified strands, and wherein the non-magnetic steel structure consists of manganese in the range 12-30 mass %, carbon in the range 0.5-1.0 mass %, aluminium in the range 0.1-1.5 mass %, silicon in the range 0.05-1.5 mass %, the remaining content of the non-magnetic steel structure being composed of iron and impurities, the non-magnetic steel structure forms part of an external shell of the refractory material and forms a non-magnetic window of the vessel for molten metal.

8. An electromagnetic stirrer or electromagnetic brake for a steel or aluminium making process, wherein the electromagnetic stirrer or electromagnetic brake comprises:
an electromagnetic circuit arranged to generate a magnetic field, and
a non-magnetic steel structure wherein the non-magnetic steel structure is one of a housing of an electromagnetic stirrer or electromagnetic brake, a window of a ladle, a window of an electromagnetic arc furnace or an aluminium furnace, a window of a casting mould, and a strand support roller for supporting semi-solidified strands, and wherein the non-magnetic steel structure consists of manganese in the range 12-30 mass %, carbon in the range 0.5-1.0 mass %, aluminium in the range 0.1-1.5 mass %, silicon in the range 0.05-1.5 mass %, the remaining content of the non-magnetic steel structure being composed of iron and impurities forming a non-magnetic housing of the electromagnetic circuit.

9. The non-magnetic steel structure as claimed in claim 2, wherein the manganese is in the range 16-30 mass %.

10. The non-magnetic steel structure as claimed in claim 2, wherein the manganese is in the range 18-30 mass %.

11. The non-magnetic steel structure as claimed in claim 3, wherein the manganese is in the range 18-30 mass %.

12. The non-magnetic steel structure as claimed in claim 2, wherein the manganese is in the range 20-30 mass %.

13. The non-magnetic steel structure as claimed in claim 3, wherein the manganese is in the range 20-30 mass %.

14. The non-magnetic steel structure as claimed in claim 2 wherein the manganese is in the range 20-25 mass %.

15. The non-magnetic steel structure as claimed in claim 3 wherein the manganese is in the range 20-25 mass %.
